(19) United States
(12) Patent Application Publication
(10) Pub. No.: US 2005/0072334 A1
(43) Pub. Date: Apr. 7, 2005

(54) Thermal interface material

(75) Inventors: Pawel Czubarow, Wellesley, MA (US); Jay Segal, Waltham, MA (US)

Correspondence Address: TOLER & LARSON & ABEL L.L.P., 5000 PLAZA ON THE LAKE STE 265, AUSTIN, TX, 78746, US

(73) Assignee: SAINT-GOBAIN PERFORMANCE PLASTICS, INC.

(21) Appl. No.: 10/681,040

(22) Filed: Oct. 7, 2003

(51) Int. Cl. C08L 91/06; C09K 3/00; B32B 5/16

(52) U.S. Cl. 106/270; 428/323; 106/230; 106/272; 106/287.3

(57) ABSTRACT

A thermal interface material is disclosed, including a polymer component, a phase component mixed with the polymer component, and a surfactant mixed with the component and the phase change component. The thermal interface material in the form of a tape, being adhered or bonded to a conductive film

### TECHNICAL FIELD OF INVENTION

This invention, in general, relates to thermal interface materials and thermal interface tapes.

### BACKGROUND

With increasing market pressure for smaller, faster, and more sophisticated end products using integrated circuits, the electronics industry has responded by developing integrated circuits that occupy less volume and operate at high current densities. Power supply assemblies for such microprocessors and the microprocessors themselves generate considerable heat during operation. For example, Intel thermal specifications for microprocessors indicate an increase in thermal power and maximum case temperature for increasing processor and core frequency. For a 2 GHz 1.5V processor, the thermal design power is 52.4 W and the maximum case temperature is 68° C. For a 2.53 GHz 1.5V processor, the thermal design power is 59.3 and the maximum case temperature is 71° C. If the heat is not adequately removed, the increased temperatures will result in degraded performance and damage to the semiconductor components.

A heat sink is commonly used to transfer the heat away from heat generating components. The heat sink generally includes a plate or body formed from a conductive metal, which is maintained in thermal contact with the assembly for dissipating heat in an efficient manner. Fins optionally protrude from the plate for providing an increased surface area for heat dissipation to the surrounding environment.

The current industry technique for providing thermal contact between a microprocessor power supply assembly and a heat sink is to interpose a thermal interface material between the two. The thermal interface facilitates heat transfer from the active device to the heat sink.

Typical thermal interface materials include thermal greases filled with thermally conductive filler, thermally conductive wax compounds, silicon rubbers, and polymeric cured-in-place compounds. Typical interface materials, such as thermal greases and polymeric cured-in-place compounds, are applied using labor-intensive and costly methods. Other typical thermal interface materials, such as silicon rubbers and polymeric cured-in-place compounds, degrade in thermal conductivity over time as a result of thermal coefficient of expansion discrepancies between the thermal interface material and the microprocessor or heat sink. Further, typical thermal interface materials, such as wax compounds loaded with a thermally conductive component, exhibit poor rheological properties leading to increased thermal impedance. As such, improved thermal conductivity materials would be desirable.

### SUMMARY OF THE INVENTION

Aspects of the invention are found in a thermal interface material comprising a polymer component, a phase change component mixed with the polymer component, and a surfactant mixed with the polymer component and the phase change component.

Additional aspects of the invention are found in a thermal interface material comprising a surfactant and a phase change wax.

Further aspects of the invention may be found in a thermal interface tape comprising a first layer and a second layer. The first layer comprises a conductive film. The second layer comprises a thermal interface material comprising a surfactant and a phase change component.

Other aspects of the invention are found in a microelectronic structure comprising an integrated circuit active device, a heat sink and a thermal interface material. A thermal interface material is disposed between and couples the integrated circuit active device and the heat sink to each other. The thermal interface tape comprises a surfactant and a phase change component.

Additional aspects of the invention are found in a method of assembling an electronic device. The method includes coupling a heat source and a heat sink to each other using a thermal interface tape disposed between the heat source and the heat sink. The thermal interface tape comprises a surfactant and a phase change component.

Further aspects of the invention are found in a thermal interface tape comprising at least one layer. The at least one layer comprises a thermal interface material having a wetting angle of not more than about 80° and a thermal impedance of less than about 0.115° C., in²/W at an operating temperature.

Further aspects of the invention are found in a thermal interface material comprising a phase change component, a surfactant, and thermally conductive filler. The thermal impedance of the thermal interface material is ≦0.8 x wherein x is the thermal impedance of a comparative thermal interface material having the same composition of the thermal interface material, but containing no surfactant.

Additional aspects of the invention are found in a thermal interface tape comprising a first layer and a second layer. The first layer comprises a conductive film. The second layer comprises a thermal interface material comprising a surfactant. The thermal interface material has a wetting angle of not more than about 80° and a thermal impedance of no more than about 0.115° C. in²/W at an operating temperature. The thermal impedance of the thermal interface material is ≦0.8 x wherein x is the thermal impedance of a comparative thermal interface material having the same composition of the thermal interface material, but containing no surfactant.

### BRIEF DESCRIPTION OF FIGURES

FIG. 1 depicts an exemplary embodiment of a system including a heat source, a thermal interface film, and a heat sink.

FIG. 2 depicts an exemplary embodiment of a thermally conductive tape.

### DETAILED DESCRIPTION

In a particular embodiment, the invention is directed to a thermal interface tape for facilitating heat transfer between a heat source and a heat sink. The thermal interface tape may include one or more layers. At least one of these layers includes a thermal interface material that softens as the heat source generates thermal energy, such as when approaching operating temperature. The softening of the thermal interface material can improve contact between the heat source or heat sink and the tape, and also improved thermal impedance between the heat source and the heat sink.

In one exemplary embodiment, the thermal interface material includes a polymer component, a phase change component, and a surfactant. The phase change component modifies the temperature at which the thermal interface material softens. According to a particular feature, the surfactant may be an ionic or a non-ionic surfactant. In particular applications, such as in microelectronic applications, the surfactant is generally non-ionic. The use of non-ionic surfactants attenuates or eliminates potential for electrical shorts in microelectronic applications. In one exemplary embodiment, the surfactant is derived from alkanolamides. In another exemplary embodiment, the surfactant may be derived from glycerin. The thermal interface material may also include thermally conductive filler, such as boron nitride, alumina, aluminum, zinc oxide, and beryllium oxide.

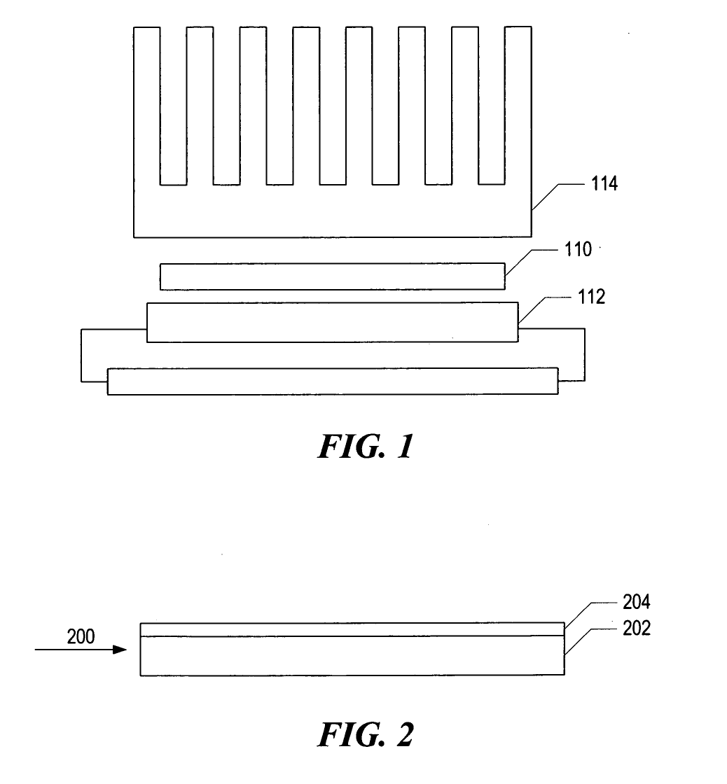

FIG. 1 depicts a thermally conductive interface material in the form of a film or tape 110 that provides a thermal interface between a heat source 112 and a heat sink 114. The heat source 112 may, for example, be an integrated circuit device such as a microprocessor or a power supply assembly. The heat sink 114 may, for example, be a conductive material with convective surface area. The thermal interface material facilitates the transfer of heat from the heat source 112 to the heat sink 114, where the heat is dissipated.

The film or tape 110 is generally about 0.025 to 2.5 millimeters in thickness. The film thickness may be increased to accommodate certain application requirements, such as larger spacing characteristics in electronics or power supply cooling application.

In one exemplary embodiment, the thermal interface material comprises a mixture of a phase change medium and dispersed thermally conductive filler. The thermal interface material may be formed into a tape, including in a roll form, or as pre-cut pieces or “stamps.” In one exemplary embodiment, the product uses die-cut parts mounted to a bandoleer web to supply continuous parts to a manual or automated part dispensing or “pick and place” part application process.

The thermal interface material may be a mixture of two or more components, one of which undergoes a reversible solid-liquid phase change or softening within a certain temperature range, typically the operating temperature of the heat source falling within such range. For example, the thermal interface material may include a polymer component, a phase change component, and a surfactant. The lowered viscosity of the thermal interface material within the phase change temperature range improves wetting of the heat sink or heat source at respective interfaces but prevents exudation and loss of contact between the components. The typical operating temperature range for a heat source, such as a microprocessor, power supply, or power electronic component such as transistors and diodes, is from about 30° C. to 150° C. The viscosity of the thermal interface material at the operating temperature is generally between about 1 and 100 poise, such as from 5 to 50 poise. In a particular embodiment, the thermal interface material maintains a viscosity of between 5 and 50 poise over the temperature range of 60-150° C. and is adapted to soften or change phase in the range of 30-120° C. When cooled below its phase change range, the thermal interface material generally solidifies without a significant change in volume, thereby maintaining intimate contact between the heat sink 114 and heat source 112.

FIG. 2 depicts an exemplary thermal interface tape structure 200. The tape 200 includes a thermal interface material layer 202 and a conductive film layer 204. The thermal interface material layer 202 may be formed with a thermal interface material. The thermal interface material may undergo a phase change or soften near the operating temperature of a heat source, such as power supply or microprocessor. The thermal interface material may include a surfactant. The thermal interface material may also include polymer components, phase change components such as low melting point waxes, thermally conductive fillers such as boron nitride, antioxidants, and coloring agents. The thermal interface material layer 202 may also include reinforcement material.

The conductive film layer 204 may include a metal or ceramic conductive material. The conductive film layer 204 may include foils such as, for example, a metallic foil such as aluminum foil or other metal foils such as copper, zinc, tin, low melting point metal alloy foils, or solders such as those based on indium, gallium, or bismuth. Other materials may include polymeric film such as polyester, polyethylene, and filled polymeric films.

The thermal interface tape structure 200 may optionally include adhesive layers. In addition, the thermal interface tape structure 200 may include removable protective layers to protect the tape during transportation, storage, and application. The protective layers may be applied using a weak adhesive or through thermal processing. The tape structure 200 may also incorporate a reinforcement layer or reinforcement material into one or more other layers, such as the thermal interface layer or a separate reinforcement layer. For example, the reinforcement material may be a fabric, such as a glass fabric.

In an exemplary embodiment, the thermal interface material includes a polymer component, a phase change component, and a surfactant. The polymer component may include single or multi-component elastomers, consisting of one or more of the following: silicone, acrylic, natural rubber, synthetic rubber, or other elastomeric materials. Examples of such elastomers include styrene butadiene rubbers, both di-block and tri-block elastomers (e.g., Kraton.RTM. from Shell Chemicals), nitrile, natural rubber, polyester resins, combinations thereof, and the like. Examples of acrylic polymers include Aeroset 1085, Aeroset 414, Aeroset 1845, Aeroset 1081, and Aeroset 1452, obtainable from Ashland Chemicals. In another example, the polymer component may be an adhesive, such as a pressure sensitive adhesive acrylic.

In an exemplary embodiment, the thermal interface material comprises from about 5% to 80% the polymer component. For example, the thermal interface material may comprise between about 5% and 25% polymer component or from about 9% to 23% polymer component by weight. The thermal interface material may comprise between about 5% to 80% phase change component by weight. For example, the thermal interface material may comprise between about 5% and 50% by weight or about 10% to 35% by weight of the phase change component. The thermal interface material may comprise between 1% and 50% surfactant by weight. For example, the thermal interface material may comprise between about 3% and 30% surfactant by weight. In one exemplary embodiment, the thermal interface material comprises greater than about 7% surfactant by weight or greater than about 10% surfactant by weight, such as between about 14% and 25% by weight. These percentages are indicative of the final product. However, during manufacture, the percentages change to reflect the addition of volatile solvents substantially removed in the manufacturing process.

Another component of the thermal interface material is a phase change component. The phase change component softens or changes phase within a phase change temperature range. The melting point is preferably around the operating temperature of the heat source. Examples of phase change components include C₁₂-C₁₆ alcohols, acids, esters, and waxes, low molecular weight styrenes, methyl triphenyl silane materials, combinations thereof, and the like. C₁₂-C₁₆ acids and alcohols include myristyl alcohol, cetyl alcohol, stearyl alcohol, myristyl acid, and stearic acid. Waxes include microcrystalline wax, paraffin waxes, and other wax-like compounds, such as cyclopentane; heceicosyl; 2-heptadecanone; pentacosaneyl; silicic acid; tetraphenyl ester; octadecanoic acid; 2-[2-[2-(2hydroxyethoxy)ethoxy]ethoxy]ethyl ester; cyclohexane; docosyl; polystyrene; polyamide resins; disiloxane 1,1,1, trimethyl-3,3; and triphenyl silane. In one exemplary embodiment, the waxes may be hydroxylated phase change waxes, such as 3337 Wax, 3335 Wax, and combinations thereof manufactured by Cognis.

A further component of the thermal interface material is a surfactant. As used herein, the term “surfactant” denotes a substance that lowers the surface or interfacial tension of the medium in which it is dissolved. The surfactant is contrasted with wetting agents or coupling agents, such as organotrialkyloxysilanes, titanates, zirconates, organic acid-chromium chloride coordination complexes, and Ken-React CAPS and KR agents, such as KR38, KR55, and CAPS L12/L, that react with both an inorganic filler and a resin matrix to form a chemical bridge between the two such as through chemisorption. The surfactant may be an ionic or a non-ionic surfactant. In exemplary applications such as microelectronic applications, the surfactant is preferably non-ionic. A non-ionic surfactant may, for example, be derived from alkanolamides or glycerin. In one exemplary embodiment, the surfactant is a Ninol surfactant by Stepan Co. such as Ninol 1301, a modified fatty alkanol amide, Ninol M10, a cocamide MIPA, or PEG-6 cocamide surfactant and other cocamide based surfactants. In another exemplary embodiment the surfactant is an ester derived from reaction between glycerin and stearic acid, such as glyceryl stearate based surfactants, such as Stepan GMS pure. Stepan Co. manufactures both Ninol and Stepan GMS pure.

Thermally conductive filler may be incorporated and dispersed in the thermal interface material. The thermally conductive filler increases the thermal conductivity of the thermal interface material and may be selected from a variety of materials having a bulk thermal conductivity of between about 0.5 and 1000.0 Watts/meter-K as measured according to ASTM D1530. Examples of conductive fillers include, but are not limited to, boron nitride, aluminum oxide, nickel powder, copper flakes, graphite powder, powdered diamond, and the like. Preferably, the particle size of the filler, the particle size distribution, and filler loading are selected to produce efficient thermal conductance. Preferably, the particle size of the filler is between about 2 and 100 microns. According to one embodiment, which is particularly suitable for sensitive microelectronic applications, the thermally conductive filler is desirably thermally conductive but generally not electrically conductive. In this respect, it is desired to have an electrical conductivity generally below about 200 ohm·cm at room temperature. Boron nitride, such as agglomerated hexagonal boron nitride, is a particularly suitable thermally conductive filler. Generally, it is desired that the filler, such as agglomerated boron nitride, form a percolated structure for desirable heat transfer through the thermal interface material.

The thermal interface material may comprise between 10% and 80% of the thermally conductive filler by weight. For example, the thermal interface material may comprise between about 10% and 50% filler by weight or between 20% and 30% filler by weight.

At the operating temperature, the thermal interface material may soften or undergo a phase change to exhibit a wetting angle of less than about 80° between the thermal interface material and the heat source or heat sink. For example, the wetting angle may be between about 30° and 80°. In another exemplary embodiment, the wetting angle may be between approximately 40° and 65°. The thermal interface material may exhibit thermal impedance below 0.130° C. in²/W based on ASTM D5470 testing method. For example, the thermal impedance may be below about 0.115° C. in²/W, below about 0.105° C. in²/W, or below about 0.095° C. in²/W. The thermal impedance for a sample with surfactant may be ≦0.8 x wherein x is the thermal impedance of a sample of similar composition without surfactant. In one exemplary embodiment, a sample having 24% by weight surfactant has a thermal impedance of 0.089° C. in²/W and a sample having similar composition and essentially no surfactant has a thermal impedance of 0.138° C. in²/W. The sample having surfactant has a thermal impedance about 40% lower than that of the sample having essentially no surfactant.

In a particular embodiment, the thermal interface material includes a phase change component, a surfactant, and thermally conductive filler. The thermal impedance of the thermal interface material is ≦0.8 x wherein x is the thermal impedance of a comparative thermal interface material having the same composition as the thermal interface material, but being free of surfactants. The comparative thermal interface material has a loading of thermally conductive filler that is equivalent to the thermal interface material of the described embodiment, and no surfactant.

To prepare the thermal interface material, components such as the polymer component, phase change component, and surfactant are generally mixed together, and the thermally conductive filler may be added. As a processing aide, a solvent may be added to the mixture. Suitable solvents include low boiling aromatics and aliphatic compounds such as toluene, benzene, zylene, heptane, mineral spirits, ketones, esters, alcohols such as isopropyl alcohol, and mixtures thereof. One exemplary solvent is toluene. Another exemplary solvent is a mixture of toluene and isopropyl alcohol. Isopropyl alcohol may assist in dissolving the phase change component in the mixture.

The mixture may be heated to about 50° C. to disperse components and then dried to form a film. During this stage, the solvent typically evaporates. Reinforcement or a conductive layer may be added or laminated to the film.

One or more layers of adhesive may optionally be applied to the film. Suitable adhesives for the adhesive layer may include Dow PSA adhesive 750D1 and 6574 and Ashland 414. The adhesive may be coated to a thickness of about 0.0002-0.0004 inches. Release layers may be applied to either surface of the film.

The thus formed tape may then be processed into discrete tabs or strips, for disposition between a heat sink and a heat source. The tape may be directly coupled to and contact a heat dissipative surface of the heat source and/or a surface of the heat sink.

According to embodiments described herein, the thermal interface material demonstrates desirable tack and peel strength. Still further, embodiments described herein demonstrate decreased thermal impedance and a decrease in operating temperature differentials across the tape. Such improvements in performance are particularly noteworthy in the context of phase change thermal interface materials, and in particular, phase change thermal interface tapes.

### EXAMPLES

Examples 1 through 5 depict exemplary mixtures used to form films. These films were tested for heat transfer properties, such as thermal impedance, and differential temperature. The films were also tested for mechanical properties such as tack and peel strength.

For Examples 1-5, the film was placed on a 2.0 GHz Pentium Tester. Temperature differential across the film was measured. Two (2.0) GHz Pentium 4 machines are outfitted with thermocouples in the heat sink and the heat spreader and the difference in temperature is measured and reported as ΔT. The heating is done with a microprocessor that is working at 100% power output. This is achieved with special software, which stresses the processor to the maximum thermal output.

For Example 6, the testing unit is a custom developed testing apparatus called Thermal Interface Materials Evaluator (TIME) with a footprint of Intel's heat spreader (27×27 mm) and conventional Dell's retention module for the heat sink. This unit is configured with two thermocouples, one in the case (the “heat spreader”) and the other one in the sink. The unit is outfitted with a heater that has adjustable wattage output. The case temperature should be sufficiently low for specific applications based on wattage output and resulting difference in temperature between heat sink and the heat spreader (ΔT). The ΔT value is directly proportional to thermal impedance.

The peel test procedure was performed in accordance with PSTC-1. The test determined the force required, in grams, to separate an adhesive-backed substrate or pressure-sensitive thermal interface material from a steel plate. The test plate was cleaned before testing with MEK and cotton pad. A 1″×6″ specimen was cut from the thermal interface material sample. A ½″ of the specimen was folded on one end of specimen and stapled. The sample was applied, adhesive side down, to the test plate. A 4.5 lb. hand roller was passed over the sample one time in each direction. The sample was peeled from test plate with peel tester within one minute, disregarding readings for first one inch and averaging readings for next two inches.

### Example 1

Table 1 depicts an exemplary mixture used to form a thermal interface film. The resulting film exhibited a 1.9° C. ΔT and peel strength of 23-33 g/in. The thermal interface material showed thermal improvement and good tack.

TABLE 1

| COMPONENT | WEIGHT % |
|---|---|
| IPA | 11.8 |
| Toluene | 4.5 |
| Irganox 1010 | 0.5 |
| 3337 Wax | 8.8 |
| 3335 Wax | 17.7 |
| Ninol 1301 | 10 |
| Boron Nitride | 24 |
| Aeroset 1081 (40% solids in toluene) | 22.7 |

### Example 2

Table 2 depicts an exemplary mixture used to form a thermal interface film. The resulting film exhibited a 1.6° C. ΔT and peel strength of 5-9 g/in.

TABLE 2

| COMPONENT | WEIGHT |
|---|---|
| IPA | 18 |
| Toluene | 4.5 |
| Irganox 1010 | 0.5 |
| 3337 Wax | 8.8 |
| 3335 Wax | 17.7 |
| Ninol 1301 | 10 |
| Stepan GMS pure | 7 |
| Boron Nitride | 24 |
| Aeroset 1081 | 9.5 |

### Example 3

Table 3 depicts an exemplary mixture used to form a thermal interface film. The resulting film exhibited a 1.5° C. ΔT and peel strength of 15-17 g/in.

TABLE 3

| COMPONENT | WEIGHT |
|---|---|
| IPA | 18 |
| Toluene | 4.5 |
| Irganox 1010 | 0.5 |
| 3337 Wax | 8.8 |
| 3335 Wax | 17.7 |
| Ninol M10 | 10 |
| Stepan GMS pure | 7 |
| Boron Nitride | 24 |
| Aeroset 1081 | 9.5 |

### Example 4

Table 4 depicts an exemplary mixture used to form a thermal interface film. The resulting film exhibited a 1.9° C. ΔT and a peel strength of 27-37 g/in.

TABLE 4

| COMPONENT | WEIGHT |
|---|---|
| IPA | 11.8 |
| Toluene | 4.5 |
| Irganox 1010 | 0.5 |
| 3337 Wax | 17.7 |
| 3335 Wax | 8.8 |
| Ninol M10 | 7 |
| Stepan GMS pure | 3 |
| Boron Nitride | 24 |
| Aeroset 1081 | 22.7 |

### Example 5

Table 5 depicts an exemplary control mixture without surfactant used to form a thermal interface film. The mixture has a thermally conductive filler loading equivalent to Examples 1-4. The resulting film exhibited a 2.2° C. ΔT and a peel strength of 0 g/in (resolution within the instrument's measurement capability). The control film exhibited a higher ΔT at operating temperatures and a higher thermal impedance.

TABLE 5

| COMPONENT | WEIGHT |
|---|---|
| IPA | 22.5 |
| Toluene | 5.0 |
| Irganox 1010 | 0.5 |
| 3337 Wax | 17.5 |
| 3335 Wax | 9.5 |
| Boron Nitride | 24 |
| Aroset 1081 | 21 |

### Example 6

Table 6 depicts wetting angle and thermal ΔT for samples having varying concentrations of surfactant. The wetting angle decreased for increased weight percents of surfactant. In addition, the thermal ΔT was generally lower for samples having surfactant.

TABLE 6

| SURFACTANT | WETTING | THERMALS ΔT |
|---|---|---|
| WT % | ANGLE | (80 W TIME) |
| 15 | 40 | 6.2 |
| 24 | 38 | 6.2 |
| 14 | 78 | 5.8 |
| 14 | 65 | 6.9 |
| N/A | 90 | 7.5 |

### Example 7

Table 7 depicts thermal impedance for two samples. Sample 1 has 24% surfactant and sample 2 is free of surfactant. The thermal impedance as measured using ASTM D5470 is lower by about 40% for Sample 1.

TABLE 7

| | | Thermal |
|---|---|---|
| | | Impedance |
| Sample | Wt % Surfactant | ° C. in²/W |
| 1 | 24 | 0.089 |
| 2 | 0 | 0.138 |

The above disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A thermal interface material comprising:
a polymer component;
a phase change component mixed with the polymer component; and
a surfactant mixed with the polymer component and the phase change component.

2. The thermal interface material of claim 1, wherein the phase change component comprises a phase change wax.

3. The thermal interface material of claim 2, wherein the phase change wax comprises hydroxylated wax.

4. The thermal interface material of claim 2, wherein the phase change wax comprises between about 5% and 50% by weight of the thermal interface material.

5. The thermal interface material of claim 2, wherein the phase change wax comprises between about 10% and 35% by weight of the thermal interface material.

6. The thermal interface material of claim 1, wherein the phase change component is adapted to soften within a temperature range of 30° C. to 120° C.

7. The thermal interface material of claim 1, wherein the polymer component comprises acrylic.

8. The thermal interface material of claim 1, wherein the polymer component comprises between about 5% and 25% by weight of the thermal interface material.

9. The thermal interface material of claim 1, wherein the polymer component comprises between about 9% and 23% by weight of the thermal interface material.

10. The thermal interface material of claim 1, further comprises a particulate thermally conductive filler.

11. The thermal interface material of claim 10, wherein the thermally conductive filler comprises boron nitride.

12. The thermal interface material of claim 10, wherein the thermally conductive filler comprises between about 10% and 50% by weight of the thermal interface material.

13. The thermal interface material of claim 10, wherein the thermally conductive filler comprises between about 20% and 35% by weight of the thermal interface material.

14. The thermal interface material of claim 1, wherein the surfactant is non-ionic or ionic.

15. The thermal interface material of claim 1, wherein the surfactant comprises a non-ionic surfactant.

16. The thermal interface material of claim 15, wherein the non-ionic surfactant is derived from alkanolamide.

17. The thermal interface material of claim 15, wherein the non-ionic surfactant is derived from cocamide.

18. The thermal interface material of claim 15, wherein the non-ionic surfactant is derived from glycerin.

19. The thermal interface material of claim 1, wherein the surfactant comprises between about 1% to 50% by weight of the thermal interface material.

20. The thermal interface material of claim 1, wherein the surfactant comprises between about 3% to 30% by weight of the thermal interface material.

21. The thermal interface material of claim 1, wherein the polymer is an adhesive.

22. The thermal interface material of claim 21, wherein the adhesive is a pressure sensitive adhesive.

23. The thermal interface material of claim 21, wherein the adhesive comprises acrylate.

24. The thermal interface material of claim 21, wherein the adhesive comprises silicone.

25. A thermal interface material comprising a surfactant and a phase change wax.

26. The thermal interface material of claim 25, wherein the phase change wax comprises between about 5% and 50% by weight of the thermal interface material.

27. The thermal interface material of claim 25, further comprising a polymer component.

28. The thermal interface material of claim 27, wherein the polymer is an adhesive.

29. The thermal interface material of claim 27, wherein the polymer component comprises between about 5% and 25% by weight of the thermal interface material.

30. The thermal interface material of claim 25, further comprising a particulate thermally conductive filler.

31. The thermal interface material of claim 30, wherein the thermally conductive filler comprises between about 10% and 50% by weight of the thermal interface material.

32. The thermal interface material of claim 25, wherein the surfactant comprises a non-ionic surfactant.

33. The thermal interface material of claim 32, wherein the non-ionic surfactant is derived from alkanolamide.

34. The thermal interface material of claim 32, wherein the non-ionic surfactant is derived from glycerin.

35. The thermal interface material of claim 25, wherein the surfactant comprises between about 1% to 50% by weight of the thermal interface material.

36. A thermal interface tape comprising:
a first layer comprising a conductive film; and
a second layer comprising a thermal interface material comprising a surfactant and a phase change component.

37. The tape of claim 36, wherein the surfactant comprises a non-ionic surfactant.

38. The tape of claim 36, wherein the surfactant is derived from alkanolamide.

39. The tape of claim 36, wherein the surfactant is derived from glycerin.

40. The tape of claim 36, wherein the thermal interface material comprises a thermally conductive filler.

41. The tape of claim 36, wherein the second layer is coupled to a protective barrier.

42. A microelectronic structure comprising:
an integrated circuit active device;
a heat sink; and
a thermal interface tape comprising a surfactant and a phase change component disposed between and coupling the integrated circuit active device and the heat sink to each other.

43. The semiconductor apparatus of claim 42, wherein the surfactant comprises a non-ionic surfactant.

44. A method of assembling an electronic device, the method comprising:
coupling a heat source and a heat sink to each other using a thermal interface tape disposed between the heat source and the heat sink, the thermal interface tape comprising a surfactant and a phase change component.

45. The method of claim 44, wherein the surfactant comprises a non-ionic surfactant.

46. The method of claim 44, wherein the heat source is a semiconductor article.

47. The method of claim 44, wherein the heat source is a power electronic device.

48. The method of claim 47, wherein the power electronic device is a transistor or a diode.

49. The method of claim 44, wherein the thermal interface material further comprises a thermally conductive filler.

50. A thermal interface tape comprising at least one layer, the at least one layer comprising a thermal interface material having a wetting angle of not more than about 80 degrees and a thermal impedance of no more than about 0.115° C. in²/W, at an operating temperature.

51. A thermal interface material comprising a phase change component, a surfactant, and a thermally conductive filler, wherein the thermal impedance of the thermal interface material is ≦0.8 x wherein x is the thermal impedance of a comparative thermal interface material having the same composition of the thermal interface material, but containing no surfactant.

52. A thermal interface tape comprising:
a first layer comprising a conductive film; and
a second layer comprising a thermal interface material coupled to the first layer, the second layer comprising a surfactant, a phase change component, a polymer, and thermally conductive filler, the thermal interface material having a wetting angle of not more than about 80 degrees and a thermal impedance of no more than about 0.115° C. in²/W, at an operating temperature, wherein the thermal impedance of the thermal interface material is ≦0.8 x wherein x is the thermal impedance of a comparative thermal interface material having the same composition of the thermal interface material, but containing no surfactant.
